(19) United States
(12) Patent Application Publication
(10) Pub. No.: US 2024/0312186 A1
(43) Pub. Date: Sep. 19, 2024

(54) MACHINE LEARNING DEVICE, MACHINE LEARNING METHOD, AND NON-TRANSITORY COMPUTER-READABLE MEDIUM HAVING MACHINE LEARNING PROGRAM

(71) Applicant: JVCKENWOOD Corporation, Yokohama-shi (JP)

(72) Inventor: Shingo KIDA, Yokohama-shi (JP)

(21) Appl. No.: 18/669,790

(22) Filed: May 21, 2024

Related U.S. Application Data
(63) Continuation of application No. PCT/JP2022/032977, filed on Sep. 1, 2022.

(30) Foreign Application Priority Data
Dec. 1, 2021 (JP) 2021-195454

(51) Int. Cl. G06V 10/70; G06V 10/77

(52) U.S. Cl. CPC G06V 10/768; G06V 10/7715

(57) ABSTRACT

A feature extraction unit extracts a feature vector from input data. A semantic prediction unit is a module has been trained in advance in a meta-learning process and that generates a semantic vector from the feature vector of the input data. A mapping unit is a module that has learned a base class and that generates a semantic vector from the feature vector of the input data. An optimization unit optimizes parameters of the mapping unit using the semantic vector generated by the semantic prediction unit as a correct answer semantic vector such that a distance between the semantic vector generated by the mapping unit and the correct answer semantic vector is minimized when semantic information is not added to input data of a novel class at the time of learning the novel class.

### CROSS REFERENCE TO RELATED APPLICATION

This application is a continuation of application No. PCT/JP2022/032977, filed on Sep. 1, 2022, and claims the benefit of priority from the prior Japanese Patent Application No. 2021-195454, filed on Dec. 1, 2021, the entire content of which is incorporated herein by reference.

### BACKGROUND

### 1. Technical Field

The present disclosure relates to machine learning technologies.

### 2. Description of the Related Art

Human beings can learn new knowledge through experiences over a prolonged period of time and can maintain old knowledge without forgetting it. Meanwhile, the knowledge of a convolutional neutral network (CNN) depends on the dataset used in learning. To adapt to a change in data distribution, it is necessary to re-train CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in successive learning.

Incremental learning or continual learning is proposed as a scheme to avoid catastrophic forgetting. Continual learning is a learning method that improves a current trained model to learn new tasks and new data as they occur, instead of training the model from scratch.

On the other hand, since new tasks often have only a few pieces of sample data available, few-shot learning has been proposed as a method for efficient learning with a small amount of training data. In few-shot learning, new tasks are learned using another small amount of parameters without relearning parameters that have been learned once.

A method called incremental few-shot learning (IFSL) has been proposed, which combines continual learning, where a novel class is learned without catastrophic forgetting of the result of learning the base class, and few-shot learning, where a novel class with fewer examples as compared to the base class is learned (Non-Patent Literature 1). In incremental few-shot learning, base classes can be learned from a large dataset and novel classes can be learned from a small number of sample data pieces.

[Non-Patent Literature 1] Cheraghian, A., Rahman, S., Fang, P., Roy, S. K., Petersson, L., & Harandi, M. (2021). Semantic-aware Knowledge Distillation for Few-Shot Class-Incremental Learning. In Proceedings of the IEEE/CVF Conference on Computer Vision and Pattern Recognition (pp. 2534-2543)

As an incremental few-shot learning method, there is Semantic-aware Knowledge Distillation (SaKD) described in Non-Patent Literature 1. In incremental few-shot learning, SaKD uses semantic (meaning) information of each class as ground truth (correct answer data) for image classification tasks. In general, an image dataset to which semantic information has been added can be used at the time of pre-learning of basic classes. However, semantic information may not be added to images used at the time of learning of novel classes. In order to learn a novel class, SaKD needs semantic information corresponding to an image of the novel class as the correct answer data, and there is a problem that images without semantic information cannot be learned.

### SUMMARY

In order to solve the aforementioned problems, a machine learning device according to one embodiment includes: a feature extraction unit that extracts a feature vector from input data; a semantic vector generation unit that generates a semantic vector from semantic information added to the input data; a semantic prediction unit that has been trained in advance in a meta-learning process and that generates a semantic vector from the feature vector of the input data; a mapping unit that has learned a base class and that generates a semantic vector from the feature vector of the input data; and an optimization unit that optimizes parameters of the mapping unit using the semantic vector generated by the semantic prediction unit as a correct answer semantic vector such that a distance between the semantic vector generated by the mapping unit and the correct answer semantic vector is minimized when semantic information is not added to input data of a novel class at the time of learning the novel class.

Another embodiment relates to a machine learning method. This method includes: extracting a feature vector from input data; generating a semantic vector from semantic information added to the input data; generating a semantic vector from the feature vector of the input data by using a semantic prediction module that has been trained in advance in a meta-learning process; generating a semantic vector from the feature vector of the input data by using a mapping module that has learned a base class; and optimizing parameters of the mapping module using the semantic vector generated by the semantic prediction module as a correct answer semantic vector such that a distance between the semantic vector generated by the mapping module and the correct answer semantic vector is minimized when semantic information is not added to input data of a novel class at the time of learning the novel class.

Optional combinations of the aforementioned constituting elements and implementations of the present embodiments in the form of methods, apparatuses, systems, recording mediums, and computer programs may also be practiced as additional modes of the present embodiments.

### BRIEF DESCRIPTION OF THE DRAWINGS

The disclosure will be described with reference to the following drawings.

FIG. 1 is a configuration diagram of a conventional machine learning device.

FIG. 2A is a diagram explaining the configuration and operation of a machine learning device according to the present embodiment at the time of learning a base class.

FIG. 2B is a diagram explaining the configuration and operation of a machine learning device according to the present embodiment at the time of learning a pseudo few-shot class.

FIG. 2C is a diagram explaining the configuration and operation of a machine learning device according to the present embodiment at the time of learning a novel class.

FIG. 3 is a flowchart explaining an incremental few-shot learning procedure performed by the machine learning device according to the present embodiment.

### DETAILED DESCRIPTION

The invention will now be described by reference to the preferred embodiments. This does not intend to limit the scope of the present invention, but to exemplify the invention.

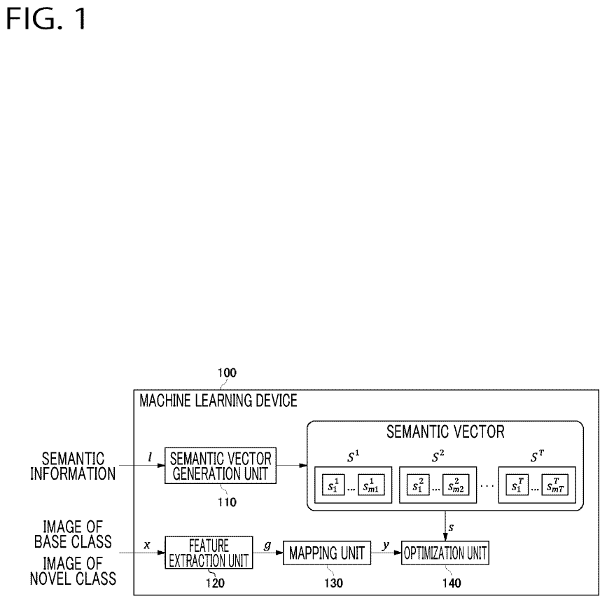

FIG. 1 is a configuration diagram of a conventional machine learning device 100. The machine learning device 100 includes a semantic vector generation unit 110, a feature extraction unit 120, a mapping unit 130, and an optimization unit 140.

In SaKD, it is assumed that semantic information for an input image is given as correct answer data when learning the base class and when learning a new class. The semantic information is, for example, in the case of an image of a cat, text information such as black or male added to the image of the cat.

At the time of the learning of a base class, the

image of the base class and semantic information thereof are input to the machine learning device 100.

The semantic vector generation unit 110 converts semantic information 1 of the image of the base class into a semantic vector s, and provides the semantic vector s to the optimization unit 140 as correct answer data.

The feature extraction unit 120 extracts a feature vector g from an image x of the base class and provides the feature vector g to the mapping unit 130.

The mapping unit 130 infers a semantic vector y from the feature vector g of the image x of the base class and provides the semantic vector y to the optimization unit 140.

The optimization unit 140 calculates the distance in a semantic space between the inferred semantic vector y of the base class and the correct answer semantic vector s as a loss, and optimizes the parameters of the feature extraction unit 120 and the parameters of the mapping unit 130 such that the loss is minimized.

In the same manner, at the time of the learning of a novel class, an image of the novel class and semantic information thereof are input to the machine learning device 100.

The semantic vector generation unit 110 converts semantic information 1 of the image of the novel class into a semantic vector s, and provides the semantic vector s to the optimization unit 140 as correct answer data.

The feature extraction unit 120 extracts a feature vector g from an image x of the novel class and provides the feature vector g to the mapping unit 130.

The mapping unit 130 infers a semantic vector y from the feature vector g of the image x of the novel class and provides the semantic vector y to the optimization unit 140.

The optimization unit 140 calculates the distance in a semantic space between the inferred semantic vector y of the novel class and the correct answer semantic vector s as a loss, and optimizes the parameters of the feature extraction unit 120 and the parameters of the mapping unit 130 such that the loss is minimized.

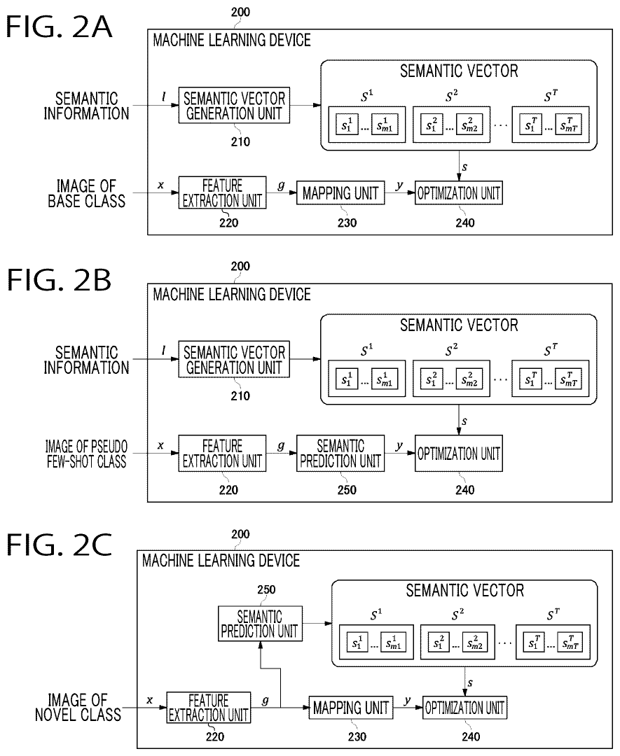

FIG. 2A to FIG. 2C are configuration diagrams of a machine learning device 200 according to an embodiment of the present disclosure. The machine learning device 200 includes a semantic vector generation unit 210, a feature extraction unit 220, a mapping unit 230, and a semantic prediction unit 250.

Images are used as examples of data input to the machine learning device 200 in the figures. However, the input data may be arbitrary data not limited to images.

FIG. 2A is a diagram explaining the configuration and operation of a machine learning device 200 at the time of learning a base class.

At the time of the learning of a base class, the image of the base class and semantic information thereof are input to the machine learning device 200. The operation at the time of the learning of the base class is the same as that at the time of the learning of a base class in the conventional machine learning device 100.

The semantic vector generation unit 210 converts semantic information 1 of the image of the base class into a semantic vector s, and provides the semantic vector s to the optimization unit 240 as correct answer data.

The feature extraction unit 220 extracts a feature vector g from an image x of the base class and provides the feature vector g to the mapping unit 230.

The mapping unit 230 infers a semantic vector y from the feature vector g of the base class and provides the semantic vector y to the optimization unit 240.

The optimization unit 240 calculates the distance in a semantic space between the estimated semantic vector y of the base class and the correct answer semantic vector s as a loss, and optimizes the parameters of the feature extraction unit 220 and the parameters of the mapping unit 230 such that the loss is minimized.

FIG. 2B is a diagram explaining the configuration and operation of the machine learning device 200 at the time of learning a pseudo few-shot class. In FIG. 2B, the parameters of the feature extraction unit 220 that has learned the base class shown in FIG. 2A are fixed for use.

An image of a pseudo few-shot class is generated from the base class. For example, five images of the base class are randomly selected, and the pseudo few-shot class is meta-learned by sequentially inputting the images into the machine learning device 200 in an episodic format as images of the pseudo few-shot class.

At the time of the meta-learning of the pseudo few-shot class, the images of the pseudo few-shot class and semantic information thereof are input to the machine learning device 200.

The semantic vector generation unit 210 converts semantic information 1 of the images of the pseudo few-shot class into a semantic vector s, and provides the semantic vector s to the optimization unit 240 as correct answer data.

The feature extraction unit 220 extracts a feature vector g from an image x of the pseudo few-shot class and provides the feature vector g to the semantic prediction unit 250.

The semantic prediction unit 250 is a module similar to the mapping unit 230, and the parameters of the mapping unit 230 that has learned the base class are used for the initial parameters of the semantic prediction unit 250.

The semantic prediction unit 250 infers a semantic vector y from the feature vector g of the pseudo few-shot class and provides the semantic vector y to the optimization unit 240.

The optimization unit 240 calculates the distance

in a semantic space between the estimated semantic vector y of the pseudo few-shot class and the correct answer semantic vector s as a loss, and optimizes the parameters of the semantic prediction unit 250 such that the loss is minimized. Since the parameters are fixed in the feature extraction unit 220 so as not to forget the knowledge of the base class, the parameters are not optimized here. Thereby, the semantic prediction unit 250 is trained in advance in a meta-learning process using the pseudo few-shot class.

For the loss function during meta-learning, the cosine distance of the semantic estimated vector y output from the semantic prediction unit 250 and the semantic correct answer vector s output from the semantic vector generation unit 210 are used, and the learning is proceeded such that this cosine distance is minimized, that is, the semantic estimated vector y approaches the semantic correct answer vector s.

FIG. 2C is a diagram explaining the configuration and operation of the machine learning device 200 at the time of learning a novel class. In FIG. 2C, the parameters of the feature extraction unit 220 that has learned the base class shown in FIG. 2A are fixed for use.

An image of the novel class may not have semantic information added to the image. A learning method used for an image of the novel class for which semantic information is not added will be explained.

At the time of the learning of a novel class, an image of the novel class is input to the machine learning device 200, and the semantic prediction unit 250 in FIG. 2B trained in advance in a meta-learning process is used for predicting semantic information from the image of the novel class.

The feature extraction unit 220 extracts a feature vector g from an image x of the novel class and provides the feature vector g to the mapping unit 230 and the semantic prediction unit 250.

The semantic prediction unit 250 predicts the semantic vector s from the feature vector g extracted from the image x of the novel class, and provides the semantic vector s to the optimization unit 240 as correct answer data.

The mapping unit 230 infers a semantic vector y from the feature vector g of the novel class and provides the semantic vector y to the optimization unit 240.

The optimization unit 240 calculates the distance in a semantic space between the estimated semantic vector y of the novel class and the correct answer semantic vector s predicted by the semantic prediction unit 250 as a loss, and optimizes the parameters of the mapping unit 230 such that the loss is minimized. Since the parameters are fixed in the feature extraction unit 220 so as not to forget the knowledge of the base class, the parameters are not optimized here. As a result, the mapping unit 230 is fine-tuned using the novel class.

When semantic information is added to the image of the novel class, it is only necessary for the semantic vector generation unit 210 to generate the correct answer semantic vector from the semantic information of the image of the novel class using the configuration explained in FIG. 2A and perform the same learning as that for the base class. This configuration makes it possible to learn and infer a novel class regardless of the presence or absence of semantic information corresponding to the novel class.

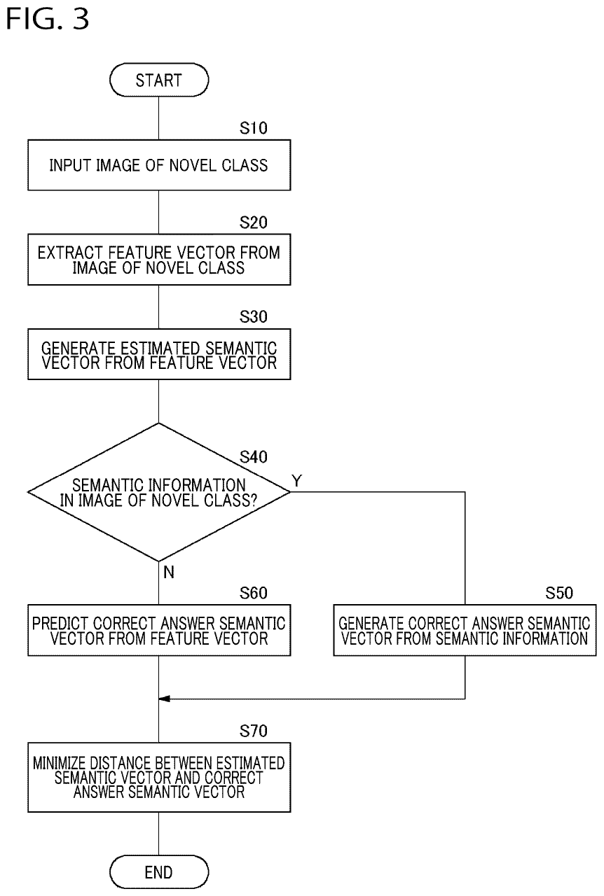

FIG. 3 is a flowchart explaining an incremental few-shot learning procedure performed by the machine learning device 200 according to the present embodiment.

An image of a novel class is input to the machine learning device 200 (S10). The feature extraction unit 220 extracts a feature vector from the image of the novel class (S20).

The mapping unit 230 generates an estimated semantic vector from the feature vector of the image of the novel class (S30).

When semantic information is added to the image of the novel class (Y at S40), the semantic vector generation unit 210 generates a correct answer semantic vector from the semantic information of the image of the novel class (S50).

When semantic information is not added to the image of the novel class (N at S40), the semantic prediction unit 250 predicts a correct answer semantic vector from the feature vector of the image of the novel class (S60).

The optimization unit 240 optimizes the parameters of the mapping unit 230 such that the distance between the estimated semantic vector and the correct answer semantic vector is minimized (S70).

The various processes of a machine learning device 200 explained above can be realized as a device using hardware such as a CPU and memory. Alternatively, the processes can be implemented by firmware stored in a read-only memory (ROM), a flash memory, etc., or by software on a computer, etc. The firmware program or the software program may be made available on, for example, a computer readable recording medium. Alternatively, the programs may be transmitted to and/or received from a server via a wired or wireless network. Still alternatively, the programs may be transmitted and/or received in the form of data transmission over terrestrial or satellite digital broadcast systems.

As described above, the machine learning device 200 according to the present embodiment generates a pseudo few-shot class from a base class and trains, in advance in a meta-learning process, a semantic prediction unit that predicts semantic information from an input image of the pseudo few-shot class. When a small number of novel classes are learned, the semantic prediction information generated by the semantic prediction unit trained in a meta-learning process is used as correct answer data so as to continuously learn the novel classes. This makes it possible to learn and infer novel classes without semantic information.

Described above is an explanation of the present disclosure based on the embodiments. The embodiments are intended to be illustrative only, and it will be obvious to those skilled in the art that various modifications to constituting elements and processes could be developed and that such modifications are also within the scope of the present disclosure.

What is claimed is:

1. A machine learning device comprising:
a feature extraction unit that extracts a feature vector from input data;
a semantic vector generation unit that generates a semantic vector from semantic information added to the input data;
a semantic prediction unit that has been trained in advance in a meta-learning process and that generates a semantic vector from the feature vector of the input data;
a mapping unit that has learned a base class and that generates a semantic vector from the feature vector of the input data; and
an optimization unit that optimizes parameters of the mapping unit using the semantic vector generated by the semantic prediction unit as a correct answer semantic vector such that a distance between the semantic vector generated by the mapping unit and the correct answer semantic vector is minimized when semantic information is not added to input data of a novel class at the time of learning the novel class.

2. The machine learning device according to claim 1, wherein the optimization unit optimizes the parameters of the mapping unit using the semantic vector generated by the semantic vector generation unit as the correct answer semantic vector such that the distance between the semantic vector generated by the mapping unit and the correct answer semantic vector is minimized when semantic information is added to the input data of the novel class.

3. The machine learning device according to claim 1,
wherein the semantic vector generation unit generates a semantic vector from semantic information added to input data of a pseudo few-shot class selected from the base class,
wherein the semantic prediction unit generates a semantic vector from a feature vector of the input data of the pseudo few-shot class, and
wherein the optimization unit optimizes parameters of the semantic prediction unit using the semantic vector generated by the semantic vector generation unit as a correct answer semantic vector such that the distance between the semantic vector generated by the semantic prediction unit and the correct answer semantic vector is minimized.

4. A machine learning method comprising:
extracting a feature vector from input data;
generating a semantic vector from semantic information added to the input data;
generating a semantic vector from the feature vector of the input data by using a semantic prediction module that has been trained in advance in a meta-learning process;
generating a semantic vector from the feature vector of the input data by using a mapping module that has learned a base class; and
optimizing parameters of the mapping module using the semantic vector generated by the semantic prediction module as a correct answer semantic vector such that a distance between the semantic vector generated by the mapping module and the correct answer semantic vector is minimized when semantic information is not added to input data of a novel class at the time of learning the novel class.

5. A non-transitory computer-readable medium having a machine learning program comprising computer-implemented modules including:
a feature extraction module that extracts a feature vector from input data;
a semantic vector generation module that generates a semantic vector from semantic information added to the input data;
a semantic prediction module that has been trained in advance in a meta-learning process and that generates a semantic vector from the feature vector of the input data;
a mapping module that has learned a base class and that generates a semantic vector from the feature vector of the input data; and
an optimization module that optimizes parameters of the mapping module using the semantic vector generated by the semantic prediction module as a correct answer semantic vector such that a distance between the semantic vector generated by the mapping module and the correct answer semantic vector is minimized when semantic information is not added to input data of a novel class at the time of learning the novel class.
